(19) United States
(12) Patent Application Publication
(10) Pub. No.: US 2006/0007347 A1
(43) Pub. Date: Jan. 12, 2006

(54) Iris controlling method for improving definition of bright object and photographing apparatus adopting the same

(75) Inventor: Su-hyog Kwon, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/110,688

(22) Filed: Apr. 21, 2005

(30) Foreign Application Priority Data
Jul. 12, 2004 (KR) 10-2004-0053979

(51) Int. Cl. H04N 5/238

(52) U.S. Cl. 348/363

(57) ABSTRACT

An iris controlling method and apparatus for improving definition of a bright object, wherein the photographing apparatus includes an iris, a controlling unit for establishing a shutting level of the iris based on a brightness level of a photographed object and which is capable of limiting the iris shutting level to be less than a predetermined shutting level which is lower than the maximum shutting level of the iris, and an iris operating unit for controlling the shutting extent of the iris based on the iris shutting level established in the controlling unit. Accordingly, degradation of the definition of the object is prevented even though the photographed object is very bright.

### CROSS-REFERENCE TO RELATED APPLICATIONS

This application claims the benefit under 35 U.S.C. §119(a) of Korean Patent Application No. 10-2004-0053979 filed with the Korean Intellectual Property Office on Jul. 12, 2004, the entire disclosure of which is hereby incorporated by reference.

### BACKGROUND OF THE INVENTION

1. Field of the Invention

The present invention relates generally to an iris controlling method and a photographing apparatus adopting the same. More particularly, the present invention relates to an iris controlling method that can control the extent of the opening and shutting of an iris automatically in order to optimize the quantity of light entering an image pickup device, and a photographing apparatus adopting such an iris controlling method.

2. Description of the Related Art

A photographing apparatus records a video signal that is generated by taking and storing an image of an object in a recording medium through a predetermined signal processing. The image of the object is taken by an image pickup device included in a photographing apparatus.

In order to take an image of the object with a high definition, the quantity of light entering the image pickup device should be maintained at an appropriate level. For this, a photographing apparatus is equipped with an iris for controlling the quantity of light entering the image pickup device.

The photographing apparatus optimizes the quantity of light entering the image pickup device by automatically controlling the level of the opening and shutting of the iris. This is called Auto Iris (AI) or Auto Exposure (AE). To be specific, AI is a function that increases the quantity of light entering the image pickup device by increasing the opening of the iris when an object is dark, and decreases the quantity of light entering the image pickup device by decreasing the opening of the iris when the object is bright.

Accordingly, when the object is very bright, the iris is shut to the maximum level. However, if the iris is shut to the maximum level, a diffraction phenomenon of incident light is maximized, which results in an adverse effect wherein the definition of the object is substantially degraded.

Accordingly, a need exists for a system and method which can prevent the maximum shutting of the iris in cases wherein the object is very bright.

### SUMMARY OF THE INVENTION

It is an aspect of the present invention to solve the above and other problems, and provide an iris controlling method that can control the level of the opening and shutting of an iris automatically to optimize the quantity of light entering an image pickup device and maintain a regular level of definition, even though an object is very bright, and a photographing apparatus adopting such an iris controlling method.

In accordance with one aspect of the present invention, a photographing apparatus is provided comprising an iris, a controlling unit for establishing a shutting level of the iris, hereinafter referred to as an iris shutting level, based on a brightness level of a photographed object and wherein the controlling unit is further capable of limiting the iris shutting level to be less than a predetermined shutting level which is lower than the maximum shutting level of the iris, and an iris operating unit for controlling the shutting extent of the iris based on the iris shutting level established in the controlling unit.

Preferably, if the iris shutting level that is established based on the brightness level of the object exceeds the predetermined shutting level, the controlling unit re-establishes the iris shutting level such that the predetermined shutting level is the re-established iris shutting level.

Preferably, if the brightness level of the object exceeds a predetermined brightness level, the controlling unit also establishes the predetermined shutting level as the iris shutting level.

In accordance with another aspect of the present invention, if the photographing apparatus is in a ‘maximum iris shutting limited mode’ for preventing the iris from being shut to the maximum level, the controlling unit limits the iris shutting level to be less than the predetermined shutting level.

The iris can be mounted on any number of devices, such as one selected from the group consisting of a digital camera, a digital camcorder, a monitoring camera, and a camera for a mobile terminal.

In accordance with another aspect of the present invention, a method for controlling an iris of a photographing apparatus is provided which comprises the steps of (a) computing a brightness level of a photographed object, (b) establishing a shutting level of the iris, hereinafter referred to as an iris shutting level, based on the brightness level of the object and limiting the iris shutting level to be less than a predetermined shutting level which is lower than the maximum shutting level of the iris, and (c) controlling the shutting extent of the iris based on the established iris shutting level.

Preferably, if the iris shutting level that is established based on the brightness level of the object exceeds the predetermined shutting level, the controlling unit re-establishes the iris shutting level such that the predetermined shutting level is the re-established iris shutting level.

Preferably, if the brightness level of the object exceeds a predetermined brightness level, the controlling unit also establishes the predetermined shutting level as the iris shutting level.

If the photographing apparatus is in a ‘maximum iris shutting limited mode’ for preventing the iris from being shut to the maximum level, the controlling unit limits the iris shutting level to be less than the predetermined shutting level.

The photographing apparatus can comprise any number of devices, such as one selected from the group consisting of a digital camera, a digital camcorder, a monitoring camera, and a camera for a mobile terminal.

### BRIEF DESCRIPTION OF THE DRAWINGS

The above aspects and features of the present invention will become more apparent by describing certain embodiments of the present invention with reference to the accompanying drawings, in which:

FIG. 1 is a block diagram illustrating a photographing apparatus that is capable of controlling an iris to improve definition of a bright object in accordance with an embodiment of the present invention;

FIG. 2 is a flowchart describing an iris controlling method for improving definition of a bright object in accordance with an embodiment of the present invention; and

FIG. 3 is a flowchart describing an iris controlling method for improving definition of a bright object in accordance with another embodiment of the present invention.

Throughout the drawings, like reference numerals will be understood to refer to like parts, components and structures.

### DETAILED DESCRIPTION OF EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and element descriptions, are provided to assist in a comprehensive understanding of the invention. Also, functions or constructions that are well-known to those skilled in the art are omitted for clarity and conciseness.

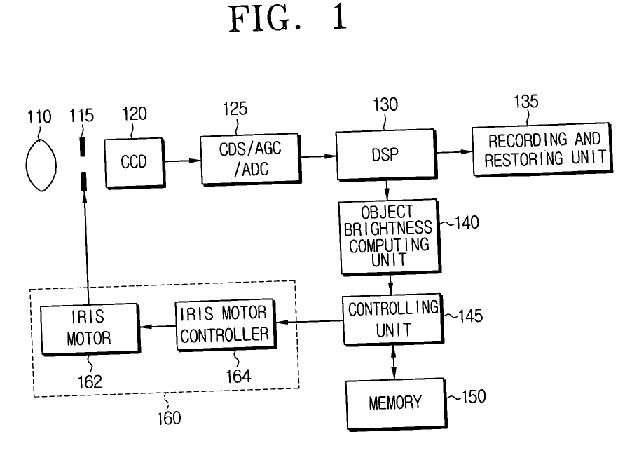

FIG. 1 is a block diagram illustrating a photographing apparatus that is capable of controlling an iris to improve definition of a bright object in accordance with an embodiment of the present invention. Referring to FIG. 1, the photographing apparatus comprises a lens 110, an iris 115, a charge-coupled device (CCD) 120, a Correlated Double Sampling Circuit/Automatic Gain Controlling Circuit/Analog to Digital Converter (CDS/AGC/ADC) 125, a digital signal processor (DSP) 130, a recording and restoring unit 135, an object brightness computing unit 140, a controlling unit 145, a memory 150, and an iris operating unit 160. The iris operating unit 160 is provided with an iris motor 162 and an iris motor controller 164.

The lens 110 focuses an optical image of an object (not shown) upon the CCD 120. The level of the opening and shutting of the iris 115 is controlled by the iris operating unit 160, which will be described in greater detail below, and the quantity of light entering the CCD 120 is determined according to the level of the opening and shutting of the iris 115. The CCD 120 converts the optical image of the object into electric signals and outputs the electric signals. It is also possible to configure yet other embodiments of the present invention to include an image pickup device comprising a Metal Oxide Semiconductor (MOS), rather than the CCD 120 shown in FIG. 1.

The CDS/AGC/ADC 125 removes noise from the output signal of the CCD 120 by using a correlated double sampling circuit (CDS), controls gain to maintain the signal at a predetermined level by using an automatic gain controlling circuit (AGC), and converts the signal into a digital video signal by using an analog-to-digital converter (ADC). The DSP 130 performs a predetermined signal processing on the video signal output from the CDS/AGC/ADC 125 and supplies the processed video signal to the recording and restoring unit 135. The recording and restoring unit 135 restores the processed video signal via a display such as Liquid Crystal Display (LCD) (not shown), or records it in a recording medium (not shown) by compressing the processed video signal into a predetermined format.

The DSP 130 also supplies a luminance Y signal, which is separated from the video signal during the signal processing, to the object brightness computing unit 140. The object brightness computing unit 140 computes a brightness level of the object based on the luminance signal provided from the DSP 130.

The controlling unit 145 controls the general operations of the photographing apparatus. More particularly, the controlling unit 145 controls the level of the opening and shutting of the iris 115. To control the level of the opening and shutting of the iris 115, the controlling unit 145 computes the shutting level of the iris 115 based on the object brightness level computed in the object brightness computing unit 140, and provides the computed iris shutting level to the iris operating unit 160.

The controlling unit 145 can further limit the iris shutting level to be less than a predetermined level to prevent a phenomenon wherein the definition of the object is deteriorated when the object is very bright as described in greater detail below.

The iris operating unit 160 controls the shutting level of the iris 115 based on the iris shutting level provided from the controlling unit 145. Specifically, when the iris motor controller 164 operates the iris motor 162 based on the iris shutting level provided from the controlling unit 145, the shutting extent of the iris 115 is controlled based on the operation of the iris motor 162.

The memory 150 is a recording medium provided for storing data needed by the controlling unit 145 for operating and/or controlling the photographing apparatus. Particularly, the memory 150 stores data required for the controlling unit 145 to control and/or limit the shutting extent of the iris 115.

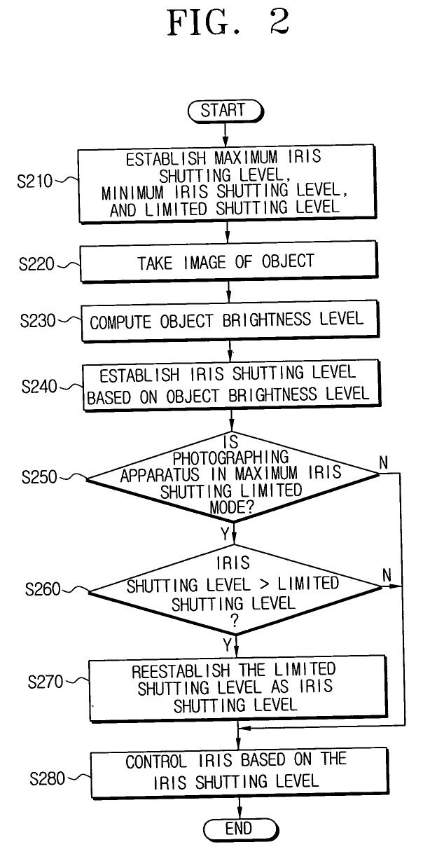

Hereinafter, an exemplary method for automatically controlling the shutting level of the iris 115 of the photographing apparatus of FIG. 1 and thereby maintaining definition of the object at a regular level, even through the object is very bright, will be described in greater detail with reference to FIG. 2. FIG. 2 is a flowchart describing an iris controlling method for improving definition of a bright object in accordance with an embodiment of the present invention.

When power is supplied to the photographing apparatus, the controlling unit 145 sets up data needed for operating and/or controlling the photographing apparatus. At step S210, the controlling unit 145 establishes the ‘maximum iris shutting level’, ‘minimum iris shutting level’, and ‘limited shutting level’, which are required for operating and/or controlling the iris 115. Specifically, the controlling unit 145 sets up the maximum iris shutting level and the minimum iris shutting level, and then sets up the limited shutting level based on the pre-established maximum iris shutting level. The maximum iris shutting level, minimum iris shutting level and limited shutting level are then stored in the memory 150.

The maximum iris shutting level is stored as control data for maximizing the shutting level of the iris 115, that is, control data for shutting the iris 115 to the maximum level. The minimum iris shutting level is stored as control data for minimizing the shutting level of the iris 115, that is, control data for opening the iris 115 to the maximum level. The limited shutting level is lower than the maximum iris shutting level by a predetermined level, and it is stored as control data for making the shutting level of the iris 115 lower than the maximum iris shutting level.

Subsequently, at step S220, if a user inputs a photographing command, an image of an object is taken by the CCD 120. Specifically, when the image is taken, the CCD 120 converts and outputs the optical image of the object as an electric signal. The CDS/AGC/ADC 125 and the DSP 130 then perform a predetermined signal processing on the output signal of the CCD 120 to thereby obtain a video signal. The DSP 130 also provides a luminance signal, which is separated from the video signal during the signal processing and provided to the object brightness computing unit 140.

At step S230, the object brightness computing unit 140 computes the brightness level of the object based on the luminance signal provided from the DSP 130 to thereby obtain an object brightness level. The object brightness computing unit 140 then provides the object brightness level to the controlling unit 145.

At step S240, the controlling unit 145 establishes an iris shutting level based on the object brightness level which was obtained at the step S230.

Subsequently, at step S250, the controlling unit 145 determines whether the photographing apparatus is in a ‘maximum iris shutting limited mode’. If the photographing apparatus is in a ‘maximum iris shutting limited mode’, the controlling unit 145 then determines at step S260 whether the iris shutting level which was established at step S240, exceeds the limited shutting level which was set up at step S210.

The maximum iris shutting limited mode denotes a photographing apparatus operation mode that prevents definition of the object from being degraded by limiting and preventing the iris from being shut to the maximum level, even when the object is very bright. The maximum iris shutting limited mode can be optionally set up or canceled by the user.

If it is determined that the photographing apparatus is in the maximum iris shutting limited mode at step S250 and that the iris shutting level exceeds the limited shutting level at step S260, the controlling unit 145 re-establishes the iris shutting level such that the limited shutting level is the re-established iris shutting level at step S270.

If the iris shutting level is re-established with the limited shutting level, the iris 115 is not shut to the maximum level, but is shut to a level that is less than the maximum shutting level. Since the iris 115 is not shut to the maximum level, the diffraction phenomenon of incident light is not maximized and thus, the definition of the photographed object is not degraded.

However, if it is determined that the photographing apparatus is not in the maximum iris shutting limited mode at step S250, or if it is determined that the iris shutting level does not exceed the limited shutting level at step S260, the controlling unit 145 does not perform the process of step S270. Therefore, the iris shutting level established in step S240 is maintained.

Subsequently, at step S280, the iris operating unit 160 controls the shutting level of the iris 115 based on the iris shutting level established in step S240 or S270. To be specific, when the iris motor controller 164 operates the iris motor 162 based on the iris shutting level provided from the controlling unit 145, the shutting level of the iris 115 is controlled based on the operation of the iris motor 162.

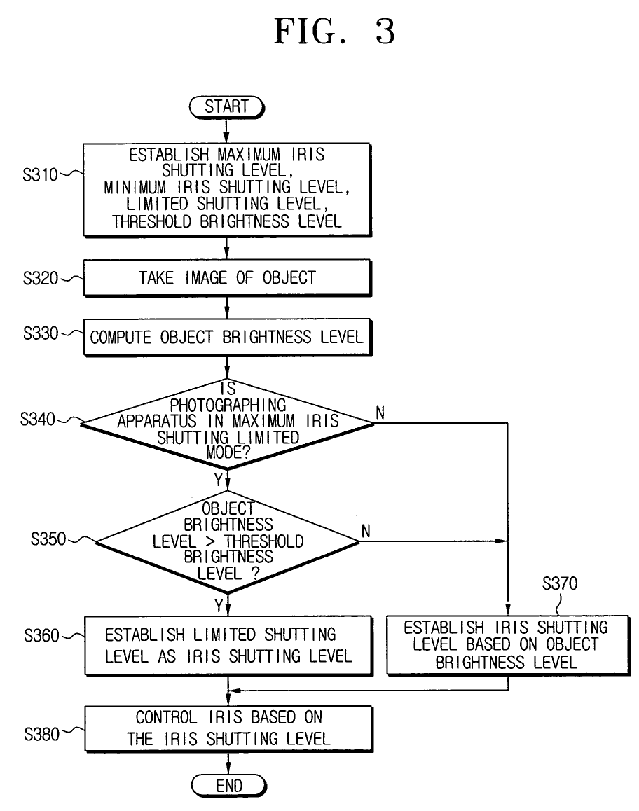

An iris controlling method that can maintain the definition of the object at a regular level, even though the object is very bright, will now be described according to another embodiment of the present invention with reference to FIG. 3. FIG. 3 is a flowchart describing an iris controlling method for improving definition of a bright object in accordance with another embodiment of the present invention.

At step S310, the controlling unit 145 sets up the ‘maximum iris shutting level’, ‘minimum iris shutting level’, ‘limited shutting level’, and ‘threshold brightness level’, which are desired for operating and/or controlling the iris 115.

The threshold brightness level is a level of brightness at which the diffraction phenomenon of incident light is maximized and the definition of the photographed object is degraded, and which can occur when the iris shutting level is established based on the brightness level of the object. The threshold brightness level can be established by referring to the limited shutting level.

Subsequently, at step S320, if the user inputs a photographing command, an image of the object is taken by the CCD 120. Then, at step S330, the object brightness computing unit 140 computes the brightness level of the object based on a luminance signal provided from the DSP 130.

At step S340, the controlling unit 145 determines whether the photographing apparatus is in the maximum iris shutting limited mode. If the photographing apparatus is in the maximum iris shutting limited mode, the controlling unit 145 then determines at step S350 whether the object brightness level which is computed at step S330, exceeds the threshold brightness level which is set up at step S310.

If it is determined that the photographing apparatus is in the maximum iris shutting limited mode at step S340 and that the object brightness level exceeds the threshold brightness level at step S350, the controlling unit 145 establishes the limited shutting level as the iris shutting level at step S360.

However, if it is determined that the photographing apparatus is not in the maximum iris shutting limited mode at step S340 or that the object brightness level does not exceed the threshold brightness level at step S350, the controlling unit 145 establishes the iris shutting level at step S370 based on the object brightness level computed at step S330.

Subsequently, at step S380, the iris operating unit 160 controls the shutting level of the iris 115 based on the iris shutting level established in step S360 or S370.

In light of the foregoing, an iris controlling method and apparatus can maintain the definition of an object at a regular level even though the object is very bright. The exemplary embodiments of the present invention can be applied to any number of devices, such as a digital camera, a digital camcorder, a monitoring camera such as a closed-circuit television (CCTV), a camera mounted on a mobile terminal, and other photographing devices.

As described above, the exemplary embodiments of the present invention can prevent the maximum shutting of the iris in cases wherein the object is very bright. Since the iris is not shut to the maximum level, even though the object is very bright, the diffraction phenomenon of incident light is not maximized. Therefore, the definition of the photographed object is not degraded.

The foregoing embodiments and advantages are merely exemplary, and are not to be construed as limiting the present invention. The present teachings can be readily applied to other types of apparatuses. Also, the descriptions of the embodiments of the present invention are intended to be illustrative, and not to limit the scope of the claims, and many alternatives, modifications, and variations will be apparent to those skilled in the art.

What is claimed is:

1. A photographing apparatus, comprising:
an iris;
a controlling unit for establishing an iris shutting level based on a brightness level of a photographed object, wherein the controlling unit is configured to limit the iris shutting level to be less than a predetermined shutting level which is lower than a maximum shutting level of the iris; and
an iris operating unit for controlling the shutting of the iris based on the iris shutting level established by the controlling unit.

2. The photographing apparatus as recited in claim 1, wherein the controlling unit is further configured to re-establish the iris shutting level if the iris shutting level established based on the brightness level of the object exceeds the predetermined shutting level, wherein the controlling unit re-establishes the iris shutting level such that the predetermined shutting level is the re-established iris shutting level.

3. The photographing apparatus as recited in claim 1, wherein the controlling unit is further configured to establish the predetermined shutting level as the iris shutting level if the brightness level of the object exceeds a predetermined brightness level.

4. The photographing apparatus as recited in claim 1, wherein the controlling unit is further configured to limit the iris shutting level to be less than the predetermined shutting level if the photographing apparatus is in a ‘maximum iris shutting limited mode’ for preventing the iris from being shut to a maximum level.

5. The photographing apparatus as recited in claim 1, wherein the iris is configured to be mounted on any one of a device selected from the group consisting of a digital camera, a digital camcorder, a monitoring camera, and a camera for a mobile terminal.

6. A method for controlling an iris of a photographing apparatus, comprising the steps of:
computing a brightness level of a photographed object;
establishing an iris shutting level based on the brightness level of the object and limiting the iris shutting level to be less than a predetermined shutting level which is lower than a maximum shutting level of the iris; and
controlling the shutting of the iris based on the established iris shutting level.

7. The method as recited in claim 6, wherein the establishing step further comprises the step of:
re-establishing the iris shutting level such that the predetermined shutting level is the re-established iris shutting level if the iris shutting level established based on the brightness level of the object exceeds the predetermined shutting level.

8. The method as recited in claim 6, wherein the establishing step further comprises the step of:
establishing the predetermined shutting level as the iris shutting level if the brightness level of the object exceeds a predetermined brightness level.

9. The method as recited in claim 6, wherein the establishing step further comprises the step of:
limiting the iris shutting level to be less than the predetermined shutting level if the photographing apparatus is in a ‘maximum iris shutting limited mode’ for preventing the iris from being shut to a maximum level.

10. The method as recited in claim 6, wherein the photographing apparatus is any one of a device selected from the group consisting of a digital camera, a digital camcorder, a monitoring camera, and a camera for a mobile terminal.
